(19) United States
(12) Patent Application Publication
(10) Pub. No.: US 2017/0071819 A1
(43) Pub. Date: Mar. 16, 2017

(54) MASTURBATION CUP

(71) Applicant: HONG KONG PASSKEY INDUSTRY CO,LIMITED, KOWLOON (HK)

(72) Inventor: XIANGRU Chen, BoLuo (CN)

(21) Appl. No.: 14/854,610

(22) Filed: Sep. 15, 2015

(51) Int. Cl. A61H 19/00

(52) U.S. Cl. CPC A61H 19/32; A61H 2201/0153; A61H 2201/1253

(57) ABSTRACT

This disclosure relates to masturbation products, in particular to a masturbation cup including an elastomer casing, and a soft plastic body formed and fixed in the elastomer casing by a secondary plastic injection process, and the soft plastic body has a channel used for male masturbation. When the masturbation cup is used, a user not just may masturbate by a thrusting motion only, but also may hold the elastomer casing and press the soft plastic body by hand to achieve a better masturbation effect.

### TECHNICAL FIELD

The technical field relates to a masturbation product, in particular to a masturbation cup (which is a male masturbation device).

### BACKGROUND

In general, conventional male masturbation devices available in the market are mainly divided into the following types: 1. A soft plastic body is formed by SEBS powder and oil through the mixing, heating, and injecting processes, and a channel (such as a channel that simulates a female vagina, etc) is formed in the soft plastic body and provided for male masturbation, and a relatively harder cup casing is made of ABS or PE and formed on an outer side of the soft plastic body. Such male masturbation device has the following shortcoming. When the masturbation device is used, a user has to hold the relatively harder cup casing and perform thrusting and vibrating actions to achieve the masturbation effect, and thus the masturbation effect is poor. 2. Only one soft plastic body with a channel used for male masturbation is available, and such male masturbation device has the shortcomings of permeating oil, adhering dust, becoming sticky, and having a pungent odor easily.

### SUMMARY

Therefore, it is a primary objective of this disclosure to overcome the aforementioned shortcomings of the prior art by providing a specially designed masturbation cup.

To achieve the aforementioned objective, this disclosure provides a masturbation cup comprising an elastomer casing, and a soft plastic body formed and fixed in the elastomer casing by a secondary plastic injection process and used as a channel for male masturbation.

Wherein, both of the elastomer casing and the soft plastic body are made of a thermoplastic elastomer (TPE) material, and the hardness of the elastomer casing is greater than the hardness of the soft plastic body.

Wherein, the elastomer casing is in a cylindrical shape with two open ends, and both ends of the soft plastic body are protruded out of both open ends of the elastomer casing respectively.

Wherein, channels are formed at both ends of the soft plastic body and used for male masturbation, and the channel at an end of the soft plastic body is in the shape of a vagina and the channel at the other end of the soft plastic body is in the shape of a mouth.

In another embodiment, channels are formed at both ends of the soft plastic body and used for male masturbation, wherein the channel at an end of the soft plastic body is in the shape of a vagina and the channel at the other end of the soft plastic body is in the shape of a buttock.

In another embodiment, channels are formed at both ends of the soft plastic body and used for male masturbation, wherein the channel at an end of the soft plastic body is in the shape of a buttock, and the channel at the other end of the plastic body is in the shape of a mouth.

The masturbation device of this disclosure has the following beneficial effect:

When the masturbation device is used, a user not just may perform the masturbation through a thrusting motion only, but also may hold the elastomer casing and press the soft plastic body by a hand to achieve a better masturbation effect.

### BRIEF DESCRIPTION OF THE DRAWINGS

FIG. 1 is a perspective view of a masturbation cup in accordance with a first preferred embodiment of this disclosure;

FIG. 2 is a side view of a masturbation cup in accordance with the first preferred embodiment of this disclosure;

FIG. 3 is a cross-sectional view of a masturbation cup in accordance with the first preferred embodiment of this disclosure;

FIG. 4 is a perspective view of an elastomer casing of a masturbation cup in accordance with the first preferred embodiment of this disclosure;

FIG. 5 is a cross-sectional view of a masturbation cup in accordance with a second preferred embodiment of this disclosure; and

FIG. 6 is a cross-sectional view of a masturbation cup in accordance with a third preferred embodiment of this disclosure.

### DESCRIPTION OF THE PREFERRED EMBODIMENTS

This disclosure will become clearer in light of the following detailed description of an illustrative embodiment described in connection with the drawings. It is intended that the embodiments and drawings disclosed herein are to be considered illustrative rather than restrictive.

### First Preferred Embodiment

A masturbation cup of this disclosure comprises an elastomer casing, and a soft plastic body formed and fixed into the elastomer casing by a secondary plastic injection process and used as a channel for male masturbation. When the masturbation cup is used, a user not just may perform the masturbation by a thrusting motion only, but also may hold the elastomer casing and press the soft plastic body by a hand to achieve a better masturbation effect.

Preferably, both of the elastomer casing and the soft plastic body are made of a TPE material, wherein the hardness of the elastomer casing is greater than the hardness of the soft plastic body, so that the soft plastic body is soft and elastic and gives a highly simulated skin texture, and the elastomer casing does not have the issues of permeating oil, sticking hands, and causing pungent odor.

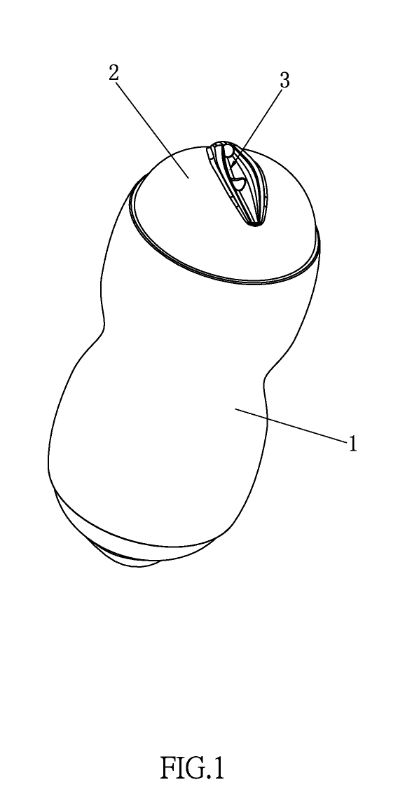

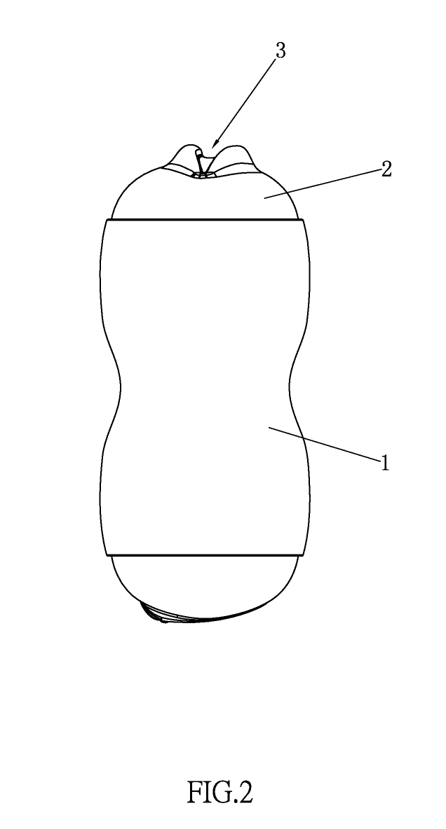

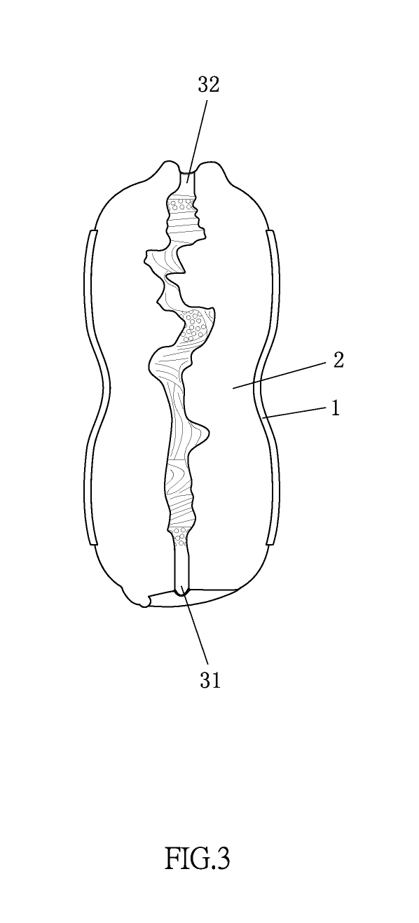

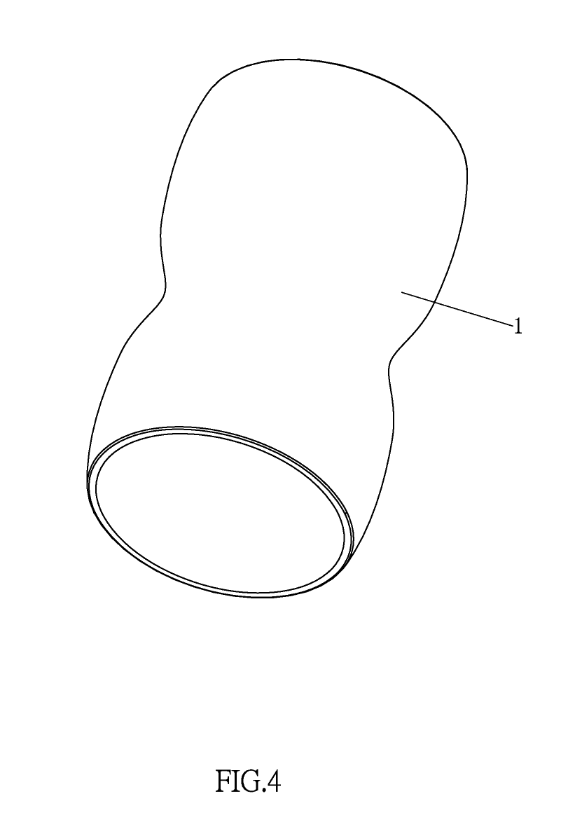

In an embodiment as shown in FIGS. 1 to 4, the elastomer casing 1 is preferably in a cylindrical shape with two open ends, and both ends of the soft plastic body 2 are protruded out of the open ends of the elastomer casing 1 respectively. In FIG. 3, both ends of the soft plastic body 2 have channels 3 used for male masturbation, wherein the channel 31 at an end of the soft plastic body 2 is in the shape of a vagina and the channel 32 at the other end of the soft plastic body 2 is in the shape of a mouth. In other words, the channel 31 in the shape of a vagina may be used for a male masturbation that simulates the feeling of a vaginal intercourse, and the channel 32 in the shape of a mouth may be used for a male masturbation that simulates the feeling of an oral sex, so that the masturbation cup of this embodiment offers two different masturbation channels 3. The masturbation cup has the advantages of easy manufacture and convenient carry. Specifically, the manufacturing process of such masturbation cup comprises the steps of using a plastic injection molding machine to form an elastomer casing 1 (as shown in FIG. 40) by a plastic injection molding process; putting the elastomer casing 1 into a mold for forming a soft plastic body 2, placing a mold core for forming a channel 3 at the center of the elastomer casing 1; and injecting a TPE material into the mold for forming the soft plastic body 2, such that the soft plastic body 2 is formed in the elastomer casing 1 by a secondary plastic injection molding process (as shown in FIG. 1). When the masturbation cup is used, a user's penis is inserted into the channel 3 of the soft plastic body 2 for male masturbation, and then holds the elastomer casing 1 to perform a thrusting or pressing motion to reach an orgasm and achieve the masturbation effect. In addition, the masturbation cup may be turned inside out for cleaning and used repeatedly.

### Second Preferred Embodiment

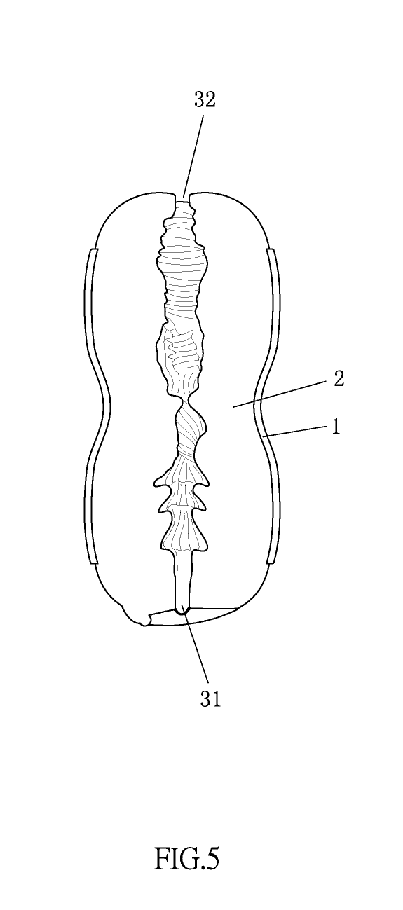

With reference to FIG. 5 for the second preferred embodiment of this disclosure, the difference between this embodiment and the first preferred embodiment resides on that channels 3 are formed at both ends of the soft plastic body 2 respectively and provided for male masturbation, wherein the channel 31 at an end of the soft plastic body 2 is in the shape of a vagina, and the channel 32 at the other end of the soft plastic body is in the shape of a buttock, so that the channel 31 in the shape of a vagina may be used for male masturbation that simulates the feeling of a vaginal intercourse, and the channel 32 is the shape of the buttock may be used for male masturbation that simulates the feeling of an anal sex, so that such masturbation cup offers two different masturbation channels 3.

Since other structures of this embodiment are the same as those of the first preferred embodiment, therefore they will not be repeated.

### Third Preferred Embodiment

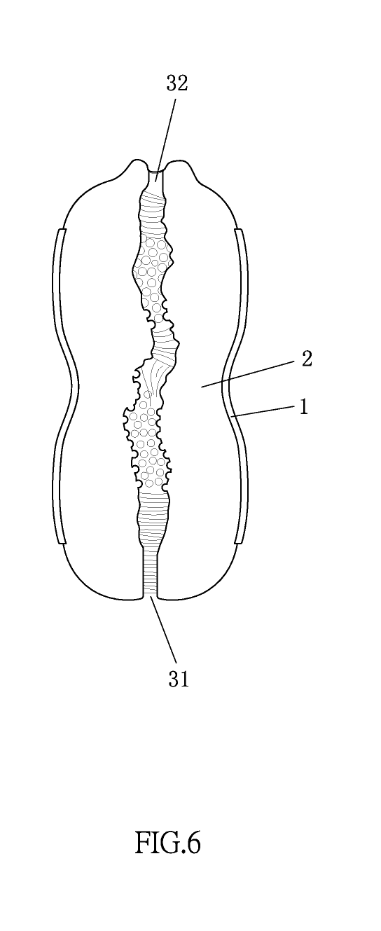

With reference to FIG. 6 for the third preferred embodiment of this disclosure, the difference between this embodiment and the first preferred embodiment resides on that channels 3 are formed at both ends of the soft plastic body 2 respectively and provided for male masturbation, wherein the channel 31 at an end of the soft plastic body 2 is in the shape of a buttock, and the channel 32 at the other end of the soft plastic body is in the shape of a mouth, so that the channel 31 in the shape of a buttock may be used for male masturbation that simulates the feeling of an anal sex, and the channel 32 in the shape of a mouth may be used for male masturbation that simulates the feeling of an oral sex, so that such masturbation cup offers two different masturbation channels 31.

Since other structures of this embodiment are the same as those of the first preferred embodiment, therefore they will not be repeated.

While this disclosure has been described by means of specific embodiments, numerous modifications and variations could be made thereto by those skilled in the art without departing from the scope and spirit of this disclosure set forth in the claims.

What is claimed is:

1. A masturbation cup, comprising: an elastomer casing, and a soft plastic body formed and fixed into the elastomer casing by a secondary plastic injection process and used as a channel for male masturbation.

2. The masturbation cup according to claim 1, wherein the elastomer casing and the soft plastic body are made of a TPE material, and the hardness of the elastomer casing is greater than the hardness of the soft plastic body.

3. The masturbation cup according to claim 2, wherein the elastomer casing is in a cylindrical shape with two open ends, and both ends of the soft plastic body are protruded out from both open ends of the elastomer casing respectively.

4. The masturbation cup according to claim 3, wherein both ends of the soft plastic body have channels used for male masturbation, and the channel at an end of the soft plastic body is in the shape of a vagina and the channel at the other end of the soft plastic body is in the shape of a mouth.

5. The masturbation cup according to claim 3, wherein both ends of the soft plastic body have channels used for male masturbation, and the channel at an end of the soft plastic body is in the shape of a vagina and the channel at the other end of the soft plastic body is in the shape of a buttock.

6. The masturbation cup according to claim 3, wherein both ends of the soft plastic body have channels used for male masturbation, and the channel at an end of the soft plastic body is in the shape of a buttock, and the channel at the other end of the plastic body is in the shape of a mouth.
